(19) United States
(12) Patent Application Publication
(10) Pub. No.: US 2021/0249831 A1
(43) Pub. Date: Aug. 12, 2021

(54) METHOD AND DEVICE FOR REMOVING A SHIELDING OF A CABLE

(71) Applicant: Rosenberger Hochfrequenztechnik GmbH & Co. KG, Fridolfing (DE)

(72) Inventor: Oliver Steinigen, Fridolfing (DE)

(21) Appl. No.: 17/163,842

(22) Filed: Feb. 1, 2021

(30) Foreign Application Priority Data
Feb. 7, 2020 (EP) 20 156 028.1
Jul. 23, 2020 (EP) 20 187 506.9

(51) Int. Cl. H01R 43/05; H01R 43/042

(52) U.S. Cl. CPC H01R 43/05; H01R 43/0427

(57) ABSTRACT

The invention relates to a method for removing an exposed shielding of a cable, according to which a cutting tool is advanced into a cutting position on an outer surface of the shielding. It is provided that a gaseous medium is injected into the cable in order to apply a radially outwardly acting force to the shielding, in such a manner that the shielding is incised by a cuter of the cutting tool.

### RELATED APPLICATIONS

This US National Phase Utility Patent Application claims priority to European Patent Application No. 20 156 028.1 which was filed on 7 Feb., 2020, and also claims priority to European Patent Application No. 20 187 506.9 which was filed on 23 Jul., 2020. The entire contents of both of the aforementioned European Patent Applications is expressly and fully incorporated herein by this reference. This claim of priority is also being made in, and is set forth in, the Application Data Sheet (ADS) filed contemporaneously herewith.

### BACKGROUND

The present invention relates to a method for removing an exposed shielding of a cable, according to which a cutting tool is applied to an outer surface of the exposed shielding in a cutting position.

The present invention also relates to a device for removing an exposed shielding.

Cables have many applications in electrical engineering and information technology for the transmission of electrical energy or for the transmission of information, or signals.

The cables known from the prior art usually have one or more conductors, which are enclosed by an insulation. A conductor enclosed by an insulation in this case is also called a core. The cores joined together to form a cable are normally surrounded by a shielding, which is usually a metallic shielding, in particular a metal foil, or a metalized foil. Furthermore, it is normally provided that the metalized foil is surrounded by a metallic outer conductor shielding, usually a braided shield. On the outside, the cable has a cable sheath, or cable sleeve, that encloses the braided shield.

If the cable has two or more cares, it is usually provided that the cores are stranded together. The stranding is effected by twisting the wires together. Various types of stranding are known from the prior art. In particular, it is known from the prior art, to strand two cores together to produce a stranded signal-line pair. It is also common in the poor art to strand four cores together. Such a cable is also called a “star quad”.

The stranding serves, inter alia to connect the cores to each other n a robust and flexible manner.

Differential signal-fine pairs, which are used for differential signal transmission, also known as symmetrical signal transmission, are of particular importance in the prior art. Differential signal-line pairs have proved effective, in particular, to enable signals to be transmitted with the greatest possible tolerance to interference, even over relatively long transmission distances. The transmission in this case is effected by means of a pair of similar signal conductors instead of only a single signal conductor. In this case, the signal is transmitted on one line and a reference signal on the other lino. A corresponding cable normally has two signal conductors, each of which is sheathed in insulation. Furthermore as described above, a shielding, a braided shield and a cable sheath are usually provided.

For cable assembly, irrespective of how many cores the cable has, it is generally provided that at one free end of the cable, the cable sheath is incised at a designated position (cut position), and the incised cable sheath piece is completely or partially pulled off the cable (full pull-off or partial pull-off). A support sleeve is then crimped onto the braided shield by means of a tool. In the next step, it may he provided that the exposed end of the cable freed from the cable sheath is trimmed to the intended length. In a further step, the braided shield is folded over the support sleeve.

If necessary, the braided shield may also be folded over without a support sleeve having first been crimped on. However, the crimping-on of the support sleeve has proved effective in mechanically stabilizing the crimping process.

After the braided shield has been folded over, the shielding underneath the braided shield, usually a metal foil, or a metalized foil, is incised, or severed, by a cutting tool. This is to expose the insulated conductor(s), i.e. the cores, beneath the shielding.

The cutting tool used to incise the shielding usually has two cutters, or blades, or knives, that incise the shielding from both sides. It is also known for the cutting tool to be configured in such a manner that, for the purpose of cutting off, it has a cutter that is rotated around the shielding. Alternatively, it is also possible to rotate the cable.

The cores can then be processed, normally in such a manner that a piece of the insulation at the end of the cores is removed such that the conductors are exposed.

The above process is easily manageable, in particular, for cables that have only one conductor. In the case of cables that have two or more than two conductors, there is the problem that the cross-sectional profile of the shielding surrounding the conductors is not round. The cross-sectional profile is usually oval.

The shielding having the oval cross-sectional profile cannot be reliably incised by the cutting tool without the risk of the underlying insulation of one of the conductors also being incised and thus damaged.

The problem is particularly pronounced in the case of stranded cables.

There is no method known from the prior art by which, in the case of cables that have two, or more than two, conductors, the shielding may be reliably removed in an automated manner. Hitherto, therefore, the shielding is removed manually, or by hand.

Owing, in particular to the great importance of differential signal line pairs, in particular stranded differential signal line pairs, to enable the cables to be processed in a reliable and cost-effective manner it is particularly important that the shielding can be reliably removed in an automated manner and that damage to the underlying insulation of the conductors is precluded, or largely precluded, since otherwise the correspondingly processed cable must be discarded.

The present invention is therefore based on the object of creating a method for removing a shielding of a cable that enables the shielding to be removed in a reliable manner.

The present invention is also based on the object of creating a device for removing a shielding of a cable that enables the shielding to be removed in a reliable manner.

The method according to the invention for removing an exposed shielding of a cable provides that a cutting tool is advanced into a cutting position on an outer surface of the shielding. According to the invention, it is provided that a gaseous medium is injected into the cable in order to apply a radially outwardly acting force to the shielding, in such a manner that the shielding is incised by a cutter of the cutting tool.

Thus, according to the invention, the cutting process is effected in that the shielding is pressed against the cutter by the injected gaseous medium and is thereby incised. There is therefore no risk of the insulation of the conductors beneath the shielding being damaged as a result to the cutting process.

Unlike the cutting process known from the prior art, in which the cutters, or the blades, of the cutting tool are advanced towards the shielding in such a manner that the cutters incise the shielding by the advance movement, the shielding moves towards the cutters of the cutting tool and is thereby incised, or cut off.

The cutting tool may have one or more cutters, which are positioned in such a manner that they surround the outer surface of the shielding radially on the outside.

Insofar as, in the context of the invention, reference is made to a cutter in respect of the cutting tool, this is to be understood to mean that more than one cutter, preferably two cutters or more than two cutters, may also be provided.

The solution according to the invention enables the cutter of the cutting tool to be positioned at a suitable stationary distance from the shielding in such a manner that the shielding is pressed against the cutter by the injected gaseous medium in such a way that the shielding is incised by the cutter. If necessary, it can be provided that the cutter of the cutting tool is also additionally advanced a defined distance towards the shielding, but it is preferable for the cutter of the cutting tool remain stationary, i.e. immobile, during the process of cutting off the shielding.

In a preferred embodiment, in which the cutting tool has two cutters, these are preferably positioned, or fixed, at a suitable fixed distance from each other in the cutting position, in such a manner that the cutters receive the cable, or the shielding of the cable, between them.

The cutter of the cutting tool is preferably advanced before the cutting process is initiated by the injection of the gaseous medium, in such a manner that the shielding is pressed against the cutter by the injected medium in such a manner that the shielding is incised in the desired manner.

It is preferably provided that the shielding is completely severed by the cutting operation. However it is also possible within the scope of the invention that the shielding is not cut through completely in depth and/or that one or more annular circumferential webs remain. It has been shown that, for the purpose of severing the shielding, it may already be sufficient if the shielding is incised over part of its depth and/or if one or more webs remain. The region of the shielding that is not completely cut through can easily be severed manually, or it has been shown that, when the cutting tool is moved away, the cutting tool preferably being moved radially outwards away from the cable following incision, the shielding adheres to the cutting tool and any regions of the shielding that have not been completely cut off are thereby torn off.

It is advantageous if the gaseous medium is injected into an interspace radially inside, or beneath, the shielding, in such a manner that the gaseous medium acts directly upon an inner surface of the shielding.

Since the gaseous medium is injected into an interspace radially inside, or beneath, the shielding, the pressure force generated by the gaseous medium acts upon the radially inner/inside surface of the shielding, inflates it and thus presses the shielding against the cutter of the cutting tool.

It is advantageous if the cutting tool, or the at least one cutter of the cutting tool, is advanced to the shielding in such a manner that the cutting tool reduces, or preferably prevents, a continued flow of the gaseous medium beneath the shielding in an axial direction. This is advantageous, in particular, in the case of short cables, as with these cables it can otherwise happen that the gaseous medium is blown through the cable. As a result of the cutting tool being advanced to the shielding, preferably such that the cutting tool contacts the shielding, the gaseous medium accumulates in the interspace in front of the cutting tool, or the pressure in the interspace increases accordingly, such that the shielding is inflated and pressed correspondingly firmly against the cutter of the cutting tool, and thus incised. As a result of being incised, the shielding then splits open in the region of the cutter, and the gaseous medium flowing out there promotes further circumferentially annular tearing-off of the shielding in the region of the cutter.

The method according to the invention results in the shielding being inflated, and thus being able to be incised, or severed, without damage to the underlying insulation of the conductors of the cable.

It is advantageous if the cable has at least one conductor or at least two conductors, and the shielding surrounds the conductor or conductors.

The method according to the invention is suitable for removing a shielding of a cable that has only one conductor, in particular a signal conductor. However, the method according to the invention is suitable, in particular, if the cable has at least one conductor or at least two conductors, in particular signal conductors. The method according to the invention can be used particularly advantageously if the cable has two conductors, in particular two signal conductors, that are surrounded by the shielding. The method is particularly suitable if the conductors, in particular the two conductors, are stranded conductors.

The method according to the invention can be used particularly advantageously if the two conductors are a signal-line pair, in particular a differential signal-line pair, especially a stranded differential signal-line pair. In the case of such cables, hitherto, the foil can only be reliably removed by hand using the measures known from in the prior art.

Insofar as reference is made below in the context of the invention to a cable having one conductor, or one core, this is to be understood in such a way that the cable may also, in particular, have more than one, or two, or more than two, conductors. The conductors are preferably realized as signal conductors, or are used accordingly, in particular as described above. Conversely, the use of the plural with respect to the conductors, or the cores, is also to be understood in such a way that only one conductor, or one core, may be provided in the cable.

The method according to the invention is suitable, in particular, for automated cable assembly.

Preferably, the method according to the invention may be integrated into an existing method for cable assembly as described above with respect to the prior art.

According to the invention, it may be provided that a gas guide is applied to a free end of the cable at which the shielding is exposed, in such a manner that the gas guide radially surrounds an axially extending portion of the exposed shielding of the cable, with a preferably annular gap remaining between an inner surface of the gas guide and the outer surface of the shielding.

Preferably, the gas guide is applied to the free end of the cable in such a manner that an annular gap remains between an inner surface of the gas guide and the outer surface of the shielding.

Preferably, the gas guide is positioned in such a manner that the gas guide radially surrounds the free end of the cable and an axially extending portion of the exposed shielding of the cable.

It is advantageous if the gas guide is positioned in such a manner that a forward end of the gas guide, pushed onto the cable, ends adjacent to the cutting tool.

It is advantageous if the gas guide ends adjacent to the cutting tool in such a manner that a distance remains between the forward end of the gas guide and the cutting tool, such that the shielding can inflate in front of the cutting tool, or the cutter, of the cutting tool, preferably in such a manner that the shielding extends at least partially radially further outwards than the inner surface of the gas guide.

The gas guide is preferably realized as a tube or hose. In particular, it may be a rigid tube, or rigid hose. Insofar as the general term gas guide is used, it may be, in particular, a tube or a hose.

It has been shown that incision, or severing, of the shielding may already be achieved in that the injected gaseous medium generates, beneath the shielding, a gauge pressure that preferably acts in the interspace between the shielding and the insulated conductors, in particular an insulated signal-line pair. The gauge pressure in this case may be generated by a gas flow which is produced by a blower and conducted, via the gas guide, from the blower to the free end of the cable, or to the end of the cable, in the interspace between the shielding and the insulated signal conductor.

Particularly advantageously, incision, or severing, of the shielding can be achieved in that a gauge pressure, or a high pressure, or a pressure pulse, is generated within a short period of time, or explosively.

A particularly advantageous method for removing a shielding is presented below.

It is advantageous if the shielding, in an opening phase, is moved radially outwards within the gas guide in such a manner that at least one annular portion of the shielding bears against (is forced radially outwardly against) an inner surface of the gas guide.

As a result of the shielding, in the opening phase, being moved radially outwards within the gas guide in such a manner that at least one annular portion of the shielding bears against the inner surface of the gas guide, the flow of the gaseous medium is introduced into the interspace below the shielding, such that the shielding is inflated particularly effectively, or a gauge pressure is generated beneath the shielding.

There are various ways of causing the shielding to bear against the inner surface of the gas guide in the opening phase. Two particularly advantageous solutions are presented below.

It is advantageous if, in the opening phase, gaseous medium is blown into the gas guide in such a manner that the gaseous medium flows past the free end of the cable, through the annular gap between the inner surface of the gas guide and the outer surface of the shielding, in the direction of the cutting tool, and/or there are openings in the gas guide through which gaseous medium is sucked outwards in order to suck the shielding onto the inner surface of the gas guide.

As a result of the gaseous medium, in the opening phase, being injected into the gas guide in such a manner that the gaseous medium flows, through the annular gap between the inner surface of the gas guide and the outer surface of the shielding, towards the cutting tool, the shielding is opened and the shielding bears against the inner surface of the gas guide. Thus, the annular gap between the inner surface of the gas guide and the outer surface of the shielding is largely, preferably completely, closed as long as the pressure is maintained.

The opening of the shielding results from the fact that the flow velocity of the gaseous medium increases in the region of the annular gap, which constitutes a constriction. To open the shielding, the inventors have exploited the so-called Bernoulli effect, according to which a lowering of the pressure (pressure drop) occurs when the flow velocity of a gas increases. The pressure in the constriction is thus lower than the pressure in the direction of flow in front of the constriction. This causes the shielding to move radially outwards, thus closing the annular gap.

Alternatively, or additionally, the opening of the shielding in such a manner that the shielding bears against the inner surface of the gas guide may also be achieved by the presence of openings in the gas guide, through which gaseous medium is sucked outwards, as a result of which the shielding is also sucked outwards, and thus bears against the inner surface of the gas guide.

With regard to the process according to the invention, it has been found advantageous to achieve the opening of the shielding by injection of the gaseous medium.

It is advantageous if, after the opening phase, in a cutting phase for the purpose of incising the shielding by means of the cutter of the cutting tool, a gaseous medium flowing in the direction of the cutting tool is injected with gauge pressure into the gas guide.

It has been shown that it is advantageous if, in a cutting phase, i.e. in the phase in which the shielding is to be incised by the cutter, the injected, or inflowing, gaseous medium is injected with gauge pressure into the gas guide. Preferably in this case, the pressure is increased compared to the pressure of the gaseous medium in the opening phase, i.e. when the shielding is first to be made to bear against the inner surface of the gas guide.

It is advantageous if a pressure surge is introduced into the gas guide in the cutting phase in order to generate the gauge pressure.

It is particularly advantageous if the gaseous medium is introduced in such a manner that an explosion effect is created, i.e. an explosive pressure surge is introduced into the gas guide.

As already mentioned above, it is particularly suitable if, in a first step (opening phase), the shielding is applied to the inner surface of the gas guide (by injection of a gaseous medium and/or by suction) and, in a second step (cutting phase), a gauge pressure is then generated.

The invention is to be understood in such a manner that the two, steps may also merge into one another, or that the opening phase is dispensed with and the gas is injected directly into the gas guide at a suitable gauge pressure.

However, it is particularly advantageous if, in the opening phase, the gaseous medium is initially injected at a first pressure that is lower than the second pressure at which the gaseous medium is injected in the cutting phase. Preferably, the second pressure is at least 1 bar, preferably at least 2 bar, higher than the first pressure.

It is also advantageous if, within the scope of the method according to the invention, the gas guide is first pushed on, or folded over, the free end of the cable at which the shielding is exposed. In the subsequent opening phase, the shielding may then be expanded or inflated accordingly without damaging the underlying conductors, or their insulation. Afterwards, the cutting tool is then advanced to an outer surface of the shielding, preferably pressed on, but preferably without already incising the shielding. Then, in the cutting phase, the shielding is pressed against the cutter in the manner already described, preferably in that a gauge pressure that is higher than the pressure in the opening phase is generated.

The cutting tool may already be positioned in the cutting position during the opening phase or preferably before the opening phase, if necessary also before the gas guide is applied.

It is advantageous if the gas guide is moved away from the cutting tool in the cutting phase while the gaseous medium is injected into the gas guide with gauge pressure.

As a result of the gas guide being moved away from the cutting tool, inflation of the shielding is facilitated, or is not hindered by the gas guide. The inventors have found that this further improves severing of the shielding. Preferably, the gas guide is moved away from the cutting tool to such an extent that the gas guide no longer radially surrounds the shielding, or exposes the shielding. Preferably, the gas guide is moved away from the cutting tool contrary to the application movement of the gas guide.

In the context of the invention, the cutting tool may be a known cutting tool, for example having one or two blades, or cutters. If necessary, it may also be provided that the cutting tool rotates during incision. Preferably, however, the cutting tool, in particular the cutters of the cutting tool, is stationary and immovable during incision.

The cutting tool may have, in particular, known shaping tools, e.g. shaping knives.

The cutting tool may also have, as an alternative or in addition to the blades or cutters, a heating wire, laser or other means for incising the shielding when the shielding is pressed against the cutting tool. The disclosure of the invention relating to the cutting tool is to be understood in such a manner, with respect to the blades or cutters, that the cutting tool may alternatively or additionally also have other means for incision or severing, in particular the aforementioned other means.

The cutting tool is preferably positioned between the axial end of the outer conductor shield of the cable and the front end of the gas guide.

Preferably, the cutting tool and the cable are positioned axially in relation to each other in such a manner that the conductors lie in a horizontal plane in the cutting plane of the cutting tool. This is particularly advantageous if the cable has two conductors, in particular two signal conductors, that are realized as a differential signal-line pair.

It is advantageous if the cutting tool has formations for receiving the conductors in the cutting position, after which, in order to insert the conductors into the formations of the cutting tool in the cutting position, the axial position of the cutting tool and/or the axial position of the cable are/is adjusted and/or the cutting tool and/or the cable are/is rotated.

In principle, the cutting tool may be a known cutting tool. However, it has been shown that it is particularly suitable if the cutting tool has formations for receiving the conductors in the cutting position. It may be provided in this case that the cutting tool is configured in such a manner that it is adapted to the number of conductors. This means that the cutting tool has formations to accommodate two conductors if the cable to be processed has two conductors.

Preferably, the cutting tool is configured in such a manner that it has two cutters, each of which has a partial formation, such that, a formation for a conductor is in each case formed by a partial formation in one of the cutters.

The cross-sectional geometry of the cutters of the cutting tool is preferably realized in such a manner that the cutters of the cutting tool together form a “spectacle-shaped” recess in the intended stationary cutting position. Alternatively, another cross-sectional geometry of the cutters, or blades, is of course also possible, for example a drop-shaped, oval or elliptical recess.

The cutting tools may also each have a V-shape. It may additionally be provided that the upper and lower cutters of the cutting tool are shaped differently.

It is advantageous if the cutting tool and the cable are positioned in relation to each other in such a manner that a straight line running orthogonally through the center axes of the two conductors extends orthogonally in relation to the advance movement of the cutting tool.

The positioning of the cutting tool and of the cable relative to each other described above has proven to be particularly suitable for incising and removing the shielding.

It is advantageous if the gas guide is configured in such a manner that it has a round cross-section. Alternatively, it may also be provided that the gas guide has a cross-sectional profile that matches the cross-sectional profile of the metal foil, i.e. the gas guide may also have, for example, an oval cross-sectional profile.

It is advantageous if a blower is used to inject the gaseous medium.

It is also advantageous if air is used as the gaseous medium.

The method according to the invention is suitable, in particular, if the shielding of the cable is realized as a metallic shielding, in particular as a metal foil, in particular as a rnetalized foil.

In principle, the method according to the invention can also be used to sever an outer conductor shield, in particular in the form of a braided shield. However, it is particularly suitable to use the method according to the invention to remove a metallic shielding, in particular a metal foil, or a metalized foil, which is preferably realized as an endless strip that is wound around the inner cores, or the insulated conductors, preferably in such a manner that the windings of the metal foil overlap over a certain circumferential segment.

The method according to the invention is preferably executed in such a manner that, in the opening phase, the shielding first contacts the inner surface of the gas guide, and as a result the gaseous medium flow is introduced into the interspace between the inner surface of the shielding and an outer surface of the insulated conductors, or a “gas-tight connection” is formed between the inner surface of the gas guide and the outer surface of the shielding.

It is advantageous if the inner surface of the gas guide has a recess against which the shielding can bear in the opening phase. The recess in the inner surface of the gas guide assists the introduction of the gaseous medium flow into the interspace, or the “gas-tight connection”, between the inner surface of the gas guide and the shielding. The recess is preferably realized in such a manner, or the gas guide is positioned with respect to the cable in such a manner, that a front end of the shielding that faces away from the cutting tool is located in the recess when the blower blows in the gaseous medium in an opening phase. Owing to the front end of the shielding being positioned inside the recess, it does not project into the gas duct of the gas guide, or into the inside of the pipe.

It has been shown that particularly good incision, or severing, of the shielding can be achieved if the gaseous medium, preferably the air, is introduced in an impulse-like manner, i.e. a large volume of air in a very short time interval (explosion effect).

The method according to the invention is suitable for a variety of cables, for example for “twisted-pair” and “parallel-pair” signal lines, as well as for multi-core cables, for example HSD (star quad); USB (four parallel signal lines) and the like.

A further alternative method for positioning the gas guide in order to remove the exposed shielding of a cable is presented below. The alternative positioning of the gas guide is characterized in that, in this case, the gas guide is not applied to the free end of the cable at which the shielding is exposed, but is positioned in front of the cable. In other words, the gas tube extends only to the free end of the cable, such that the gaseous medium flowing out of the gas tube flows against an end face of the free end of the cable.

All the other features and embodiments of the invention mentioned above and also those mentioned below may, of course, be applied equally or analogously for both types of positioning of the gas guide, unless this is explicitly excluded on the basis of the way in which the gas guide is positioned.

The alternative positioning of the gas guide is characterized in that a gas guide, through which the gaseous medium is injected into the cable, and a free end of the cable, at which the shielding is exposed, are positioned relative to each other in such a manner that an outlet opening of the gas guide is positioned in front of an end face of the free end of the cable.

Also as a result of the gas guide being positioned in such a manner, the gaseous medium can be injected into the cable in such a manner that the shielding is subjected to a radially outwardly acting force in such a manner that the shielding is incised by the at least one cutter of the cutting tool. The pressure with which the gaseous medium, preferably air, is injected into the cable may be selected in a suitable manner.

It has been found to be advantageous if the gaseous medium is injected into the cable by means of a pressure surge, or an explosive pressure surge, as already described above. Owing to the positioning of the gas guide in front of the end face of the free end of the cable, the gaseous medium is blown, or flows, against the end face of the free end of the cable, as a result of which the shielding becomes inflated, or distended, and is subsequently incised by the cutter of the cutting tool.

The cutting tool may preferably be positioned in such a manner as shown above. Preferably, it is provided in this case that the cutting tool is already positioned in the cutting position before the gaseous medium is injected into the cable, or before the pressure surge occurs.

It is advantageous if the outlet opening is positioned adjacently, preferably closely adjacently, in front of the free end of the cable, in such a manner that the gaseous medium flowing out of the outlet opening is aligned with the end face of the free end of the cable.

As a result of the outlet opening being positioned adjacently to, preferably closely adjacently to, in particular directly adjoining, the end face of the free end of the cable, or substantially in the same axial position as the end face of the free end of the cable, the pressure upon the end face of the free end of the cable, or the pressure with which the gaseous medium is injected into the cable, in particular into an interspace radially inside the shielding, is particularly high. The gaseous medium thus acts with a high pressure upon an inner surface of the shielding and distends it, or presses it radially outwards, such that the shielding is incised in a particularly reliable manner by the at least one cutter of the cutting tool.

The outlet opening may preferably be at a distance of less than 50 mm, more preferably less than 30 mm, more preferably less than 20 mm, in particular less than 10 mm, particularly preferably less than 5 mm, and most preferably less than 2 mm, in particular less than 1 mm, from the end face of the free end of the cable. The gaseous medium thus flows in a targeted manner against the end face of the free end of the cable, as a result of which the gaseous medium is injected particularly efficiently into an interspace radially inside the shielding.

Preferably, the gas guide is positioned in such a manner that a central axis of the free end of the cable and a central axis of the outlet opening, or a central axis of an adjoining duct of the gas guide, are substantially coaxial with each other.

The outlet opening may preferably have a circular cross-sectional area. However, other cross-sectional areas are also possible, for example an oval cross-sectional area. The cross-sectional area of the outlet opening may also in this case be adapted to the area, or shape, of the end face of the cable.

The cross-sectional area, or the diameter, of the outlet opening may be larger or smaller than the diameter of the end face of the free end of the cable. The cross-sectional area, or the diameter, of the end face of the free end of the cable in this case is generally composed of the cross-sectional area of the conductor or conductors and the cross-sectional area of the insulation and of the shielding surrounding the conductor or conductors.

According to the invention, it may also be provided that the diameter of the outlet opening, or the cross-sectional area of the outlet opening, is the same as the cross-sectional area, or the diameter, of the end face of the free end of the cable.

It is advantageous if the gas guide has at least one additional nozzle, (a second nozzle) and preferably a plurality of additional nozzles.

The generation of an additional pressure, i.e. a flow of gas or air, through at least one additional (second) nozzle, in addition to the outlet opening, enables the removal of the exposed shielding to be further improved.

It is advantageous if the at least one additional nozzle (second nozzle) is arranged radially outside the outlet opening.

It may be particularly advantageous if a plurality of additional nozzles are arranged radially around the outlet opening, preferably spaced at an equal distance from each other. For example, two, three, four, five, six, seven or eight additional nozzles may be provided, arranged at an equal angular distance from each other around the outlet opening.

The additional nozzles may also be positioned radially further outwards than the end face of the free end of the cable.

It has been found to be advantageous if the additional nozzles are punctiform, as this is easier to realize than a hollow-cylindrical design of the additional nozzles, which would, however, also be technically possible in principle.

It is advantageous if the at least one additional nozzle is arranged in such a manner that the gaseous medium flowing out of the additional nozzle flows in the direction of a central axis of the cable.

Preferably, a plurality of additional nozzles are arranged, and the gaseous medium flowing out of the additional nozzles may be directed towards a common point along the central axis of the cable or towards the center of the end face of the free end of the cable. It may also be provided, however, that the additional nozzles are each aligned in pairs, or also only singly, with a point on the central axis, and the points may each be arranged offset from one another in the axial direction along the central axis.

It is advantageous if the at least one additional nozzle is moved, preferably rotated about a central axis of the outlet opening in order to generate a vortex.

It has been found to be advantageous if a vortex is generated, preferably an air vortex, as this yet further improves the removal of the shielding.

An air vortex can be created in a particularly advantageous manner by rotating the additional nozzles about a central axis of the outlet opening. Alternatively, it may also be provided that the additional nozzles execute some other controlled movement, for example in order to align them with different points, preferably along the central axis of the cable. It may also be provided that the additional nozzles oscillate. Furthermore, it may be provided that the additional nozzles are arranged together on a ring that surrounds the outlet opening and that can be oscillated and/or rotated about the outlet opening.

It is advantageous if the gas guide is of a multipart, preferably two-part design, and the parts of the gas guide are positioned, or controllably moved, preferably in coordination with the cutting tool, to inject the gaseous medium into the cable.

A multipart, preferably a two-part design of the gas guide may be advantageous in order to position the gas guide in the intended position, i.e. either in front of the end face of the free end of the cable or in such a manner that the gas guide radially surrounds an axially extending portion of the exposed shielding of the cable. It may be provided that each of the parts of the multipart gas guide, for example the two parts, each realize a part of the duct through which the gaseous medium, for example driven by a blower, flows towards the cable. It may also be provided, however, that the duct is realized only in one part of the multipart gas guide, for example also only in one part of the two-part gas guide, and the respective other part or parts serve substantially to close the duct in the manner of a cover.

In principle, but in particular also in the case of a multipart, in particular two part gas guide, it may be provided that the duct not only runs linearly, but that one or more bends are provided. It may thus be provided, for example, that an infeed portion of the duct runs in a first direction, and an outflow portion of the duct, which is aligned with the cable, or the central axis of which runs substantially parallel to the central axis of the cable, is aligned at an angle to the infeed portion, for example by 45° to 135°, in particular also by 90°. This may be advantageous in order to ensure a compact structure or, for example, to enable a blower for generating the flow to be suitably positioned, or connected to the infeed portion.

It may also be advantageous if the infeed portion extends in such a manner that it runs substantially in a direction in which the respective part of a multipart gas guide is displaced in order to bring it into the injection position. The injection position in this case is to be understood as the position assumed by the multipart gas guide in order to inject the gaseous medium into the cable. Such an orientation may be advantageous, as thus the hoses or pipes connected to the infeed portion can track the movement particularly easily. Moreover, such an arrangement may be advantageous in enabling a motor actuator, for adjusting the multipart gas guide, to be positioned in a suitable manner.

It may be advantageous if the multipart, preferably two-part, gas guide is positioned in coordination, with the cutting tool. For this purpose, it may be provided that the cutting tool and the gas guide are positioned in a suitable alignment with each other, for example electronically controlled.

In a particularly advantageous embodiment, it may be provided that the cutting tool and the gas guide are mechanically connected to each other, such that their positioning relative to each other is fixed, and the unit consisting of the gas guide and the cutting tool can thus be brought jointly, for example, into the cutting position, and returned again.

It may be advantageous if the gas guide is of a two-part design and the cutting tool is of a two-part design, such that in each case a first part of the cutting tool is assigned to a first part of the gas guide and a second part of the cutting tool is assigned to a second part of the gas guide, in particular in that the parts are mechanically connected to each other in a fixed manner, and can thus be positioned jointly.

It is advantageous if the gas guide, the cutting tool and/or the cable are moved axially, i.e. towards each other and/or away from each other, while the gaseous medium is being injected into the cable.

In particular, it may be provided that the cutting tool is moved relative to the cable. Moreover, it may in particular be provided that the gas guide is moved relative to the cable. Moreover, it may in particular be provided that the cable is moved relative to the cutting tool and/or the cable is moved relative to the gas guide. Moreover, a relative movement between the gas guide and the cutting tool may also be advantageous.

If there is a relative movement between the cable and the cutting tool that grips, or clamps, the cable, in particular in the axial direction, this promotes tearing-off of the shielding or of the foil. Even a small axial movement may be sufficient for this purpose. The relative movement is preferably executed while the gas is being injected.

Axial movement of at least one of the aforementioned components may further enhance the severing of the shielding.

Such a movement may be suitable irrespective of whether the gas guide is positioned in front of an end face of the free end of the cable or whether the gas guide radially surrounds an axially extending portion of the exposed shielding of the cable.

Provided, in the case of the device according to the invention, is a cutting tool that, for the purpose of severing the shielding, can be advanced to an outer surface of the shielding.

According to the invention, a gas guide and a blower are provided to inject a gaseous medium beneath the shielding in such a manner that the shielding is subjected to a radially outwardly acting force, in such a manner that a cutter of the cutting tool incises the outwardly pressed shielding.

The device according to the invention makes it possible, particularly advantageously, to remove the exposed shielding at one end of a cable.

With regard to the positioning of the gas guides, two alternative embodiments have been found to be particularly suitable.

According to the invention there may be provided, in a first advantageous embodiment, a gas guide that can be applied to the end of the cable at which the shielding is exposed, in such a manner that the gas guide radially surrounds a portion of the exposed shielding extending in the axial direction of the cable, wherein the gas guide is configured in such a manner that an annular gap remains between the inner surface of the gas guide and the outer surface of the shielding, and wherein a blower is provided for injecting a gaseous medium inside, or beneath, the shielding in such a manner that the shielding is subjected to a radially outwardly acting force, in such a manner that a cutter of the cutting tool incises the outwardly pressed shielding.

The gaseous medium, preferably air, is preferably injected into an interspace radially inside, or beneath, the shielding.

It is advantageous if the device is configured in such a manner that the inner surface of the gas guide has a recess, and the gas guide is positioned with respect to the cable in such a manner that a front end of the shielding that faces away from the cutting tool is located in the recess wren the blower blows in the gaseous medium in an opening phase.

According to the invention it may be provided, in a second advantageous embodiment, that the gas guide and the end of the cable are positioned relative to each other in such a manner that an outlet opening of the gas guide is positioned in front of an end face of the end of the cable. In this embodiment, it is provided that the gas guide is routed only to the end of the cable and does not enclose a portion of the cable.

Preferably, the gas guide is positioned adjacently, preferably closely adjacently, in front of the free end of the cable. Preferably, only a minimal, or least possible, distance remains between the outlet opening of the gas guide and the free end of the cable.

In addition to the outlet opening, the gas guide may preferably have at least one additional (second) nozzle, preferably a plurality of additional nozzles, which are oriented inwards, i.e. the outflowing gaseous medium is oriented in the direction of a central axis of the outlet opening, and thus also in the direction of a central axis of the cable.

For both embodiments it may be advantageous if the gas guide is of a multipart, preferably two-part, design.

Furthermore, it may be advantageous if the multipart, preferably two-part, gas guide is positioned jointly with a cutting tool that is preferably of a two-part design. The two parts of the cutting tool and the preferably two parts of the gas guide may in this case be configured in such a manner that a first part of the gas guide is connected to a first part of the cutting tool, and a second part of the gas guide is connected to a second part of the cutting tool. It is thus ensured that the cutting tool and the gas guide are each positioned in a defined manner relative to each other, in particular that they can brought jointly into the cutting position and returned again.

Preferably, the first cutting tool is an upper cutting tool, and the second cutting tool is a lower cutting tool, each having a cutter.

The advantages of the device according to the invention are disclosed analogously by the statements relating to the method according to the invention.

Features already described in connection with the method according to the invention can, of course, also be advantageously realized for the device according to the invention—and vice versa. Moreover, advantages mentioned in connection with the method according to the invention may also be understood in relation to the device according to the invention—and vice versa.

In addition, it should be noted that terms such as “comprising”, “having” or “with” do not exclude other features or steps. Moreover, terms such as “a” or “the” that indicate a single number of steps or features, do not exclude a plurality of features or steps—and vice versa.

Exemplary embodiments of the invention are described in greater detail in the following.

### SUMMARY

A principle aspect of the present invention is a method for removing an exposed shielding from a cable comprising the steps of: providing a cutting tool that has a cutter; advancing the cutting tool into a cutting position adjacent an outer surface of the exposed shielding; providing a gaseous medium, and injecting the gaseous medium into a free end of the cable to apply a radially outwardly acting force upon the exposed shielding so that the exposed shielding is incised by the cutter of the cutting tool.

A further aspect of the present invention is a method wherein the gaseous medium is injected into an interspace radially inside the exposed shielding; and the injected gaseous medium acts directly upon an inner surface of the exposed shielding.

A further aspect of the present invention is a method further comprising the step of: providing a gas guide and applying the gas guide to a free end of the cable where the shielding is exposed, in a manner wherein the gas guide radially surrounds an axially extending portion of the exposed shielding of the cable, and an annular gap is between an inner surface of the gas guide and an outer surface of the shielding.

A further aspect of the present invention is a method further comprising the step of: providing an opening phase wherein the exposed shielding is moved radially outwards within the gas guide in such a manner that at least one annular portion of the exposed shielding bears against an inner surface of the gas guide when the gaseous medium is injected into the interspace.

A further aspect of the present invention is a method further comprising the step of: providing a cutting phase that occurs after the opening phase, and wherein, in the cutting phase, for the purpose of incising the exposed shielding by means of the cutter of the cutting tool the gaseous medium flows in the direction of the cutting tool and is injected with gauge pressure into the gas guide.

A further aspect of the present invention is a method further comprising the step of: providing a pressure surge that is introduced into the gas guide in the cutting phase in order to generate the gauge pressure.

A further aspect of the present invention is a method further comprising the step of: providing a gas guide through which the gaseous medium is injected into the cable at the free end of the cable, at which the shielding is exposed, and the gas guide and the free end of the cable are positioned relative to one another in such a manner that an outlet opening defined by the gas guide is positioned in front of an end face of the free end of the cable.

A further aspect of the present invention is a method wherein the outlet opening of the gas guide is positioned adjacent the free end of the cable so that the gaseous medium flowing out of the outlet opening is generally coaxially aligned with the end face of the free end of the cable.

A further aspect of the present invention is a method further comprising: a second nozzle defined in the gas guide, proximate to the outlet opening defined in the gas guide, through which the gaseous medium flows.

A further aspect of the present invention is a method wherein the second nozzle is arranged radially outward of the outlet opening, and the second nozzle is positioned relative to the outlet opening defined in the gas guide so that the gaseous medium flowing out of the second nozzle flows in the direction of a central axis of the cable.

A further aspect of the present invention is a method wherein the gas guide is a multi-part design, and the multi-parts of the gas guide are positioned, in coordination with the cutting tool, to inject the gaseous medium into the free end of the cable.

A further aspect of the present invention is a method further comprising the step of: controllably moving the gas guide and the cutting tool relative to one another while the gaseous medium is being injected into the free end of the cable.

A further aspect of the present invention is a device for removing an exposed shielding at an end of a cable comprising: a cutting tool having a cutter that can be advanced to an outer surface of the exposed shielding; and a gas guide; and a blower, and wherein the blower operatively communicates with the gas guide to provide a pressurized gaseous medium thereto, and the gas guide is positioned and oriented relative to a free end of the cable to inject the pressurized gaseous medium beneath the exposed shielding so that the exposed shielding is subjected to a radially outwardly acting force, in such a manner that the cutter of the cutting tool incises the outwardly pressed exposed shielding.

A still further aspect of the present invention is a device wherein the gas guide is applied to the free end of the cable at which the shielding is exposed, in such a manner that the gas guide radially surrounds a portion of the exposed shielding extending in the axial direction of the cable, and wherein the gas guide is configured so that an annular gap is between an inner surface of the gas guide and an outer surface of the exposed shielding.

A still further aspect of the present invention is a device wherein the gas guide and the free end of the cable are positioned and oriented, relative to each other, in such a manner that an outlet opening defined in the gas guide is positioned in front of an end face of the free end of the cable and is coaxially aligned therewith.

An even still further aspect of the present invention is a device wherein the injection of the pressurized gaseous media into the free end of the cable, and below the shielding, causes the exposed shielding to move radially outwardly to engage the cutter of the cutting device to cause the incising of the exposed shielding.

An even still further aspect of the present invention is a method wherein the second nozzle is arranged radially outward of the outlet opening.

An even still further aspect of the present invention is a method wherein the second nozzle is positioned relative to the outlet opening defined in the gas guide so that the gaseous medium flowing out of the second nozzle flows in the direction of a central axis of the cable.

An even still further aspect of the present invention is a method wherein the second nozzle is rotated about a central axis of the outlet opening to generate a vortex.

These and other aspects of the present invention are disclosed further and in more detail herein.

### BRIEF DESCRIPTIONS OF THE DRAWINGS

The figures show preferred exemplary embodiments, in which individual features of the present invention are represented in combination with each other. However, the invention is not limited to the combination represented.

In the figures, elements that are functionally equivalent are denoted by the same references.

There are shown, in schematic form:

FIG. 1 is an orthographic side view of a general representation of a partially stripped cable.

FIG. 2 is an orthographic cross-section view of the cable represented in FIG. 1.

FIG. 3 is a side view of the cable represented in FIG. 1, with a braided shield having been folded over, and a cutting tool having been advanced to an outer surface of a shielding of the cable.

FIG. 4 is an orthographic cross-section view of the cable represented in FIG. 3.

FIG. 5 is a side view representation of the cable of FIG. 3, with a gas guide applied to the free end of the cable.

FIG. 6 is an orthographic, partial cross-section, side view representation of an opening phase of the method, in which a gaseous medium is injected into the gas guide which surrounds the cable of FIG. 1.

FIG. 7 is an orthographic, partial cross-section, side view representation, similar to FIG. 6, showing the shielding opened due to the inflowing gaseous medium and bearing against the inner surface of the gas guide.

FIG. 8 is an enlarged general detail representation of a portion of FIG. 7, showing a front end of the shielding of the cable, bearing in a recess, against an inner surface of the gas guide.

FIG. 9 is an orthographic, partial cross-section, side view representation of a cutting phase of the method according to the invention, in which the shielding is inflated by a gauge pressure to such an extent that the shielding presses against cutters of the cutting tool.

FIG. 10 is a side view representation of the severed shielding after the cutting phase.

FIG. 11 is an orthographic, partial cross-section, side view representation of a second contemplated embodiment of the invention showing the gas guide positioned in front of an end face of the free end of the cable.

FIG. 12 is an orthographic, partial cross-section, side view representation similar to FIG. 11 showing the shielding inflated by the injected gaseous medium.

FIG. 13 is an orthographic, cross-section, side view of a portion of the gas guide, and showing the gas guide having additional nozzles.

FIG. 14 is a perspective end view representation of the gas guide of FIG. 13 having additional nozzles that are rotatable to create a vortex.

FIG. 15 is a simplified general representation of a multipart gas guide.

### DETAILED WRITTEN DESCRIPTION OF THE PREFERED EMBODIMENTS

This disclosure of the invention is submitted in furtherance of the Constitutional purposes of the U.S. Patent laws “to promote the progress of science and useful arts (Article 1, Section 8).

Referring now to the drawings, FIGS. 1 to 10 show a first particularly preferred exemplary embodiment for executing the method according to the invention for removing an exposed shielding 1 of a cable 2. The method according to the invention is not limited to the method represented in the exemplary embodiment. Rather, the individual method steps may also be combined with other method steps, or method steps may be omitted.

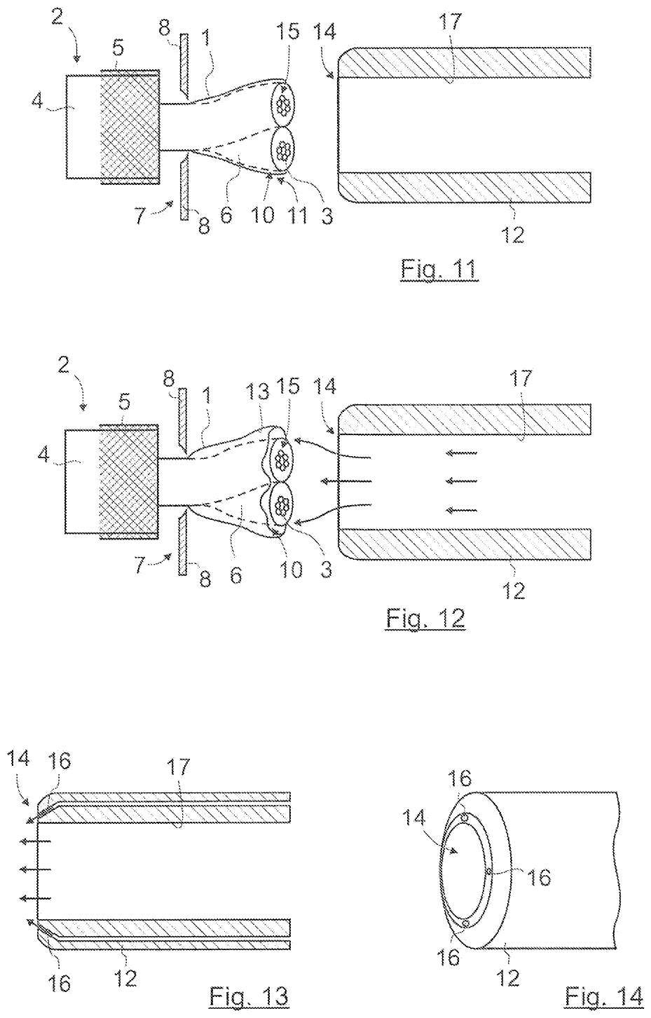

In particular, the description relating to FIGS. 1 to 4 also applies to a second preferred embodiment according to FIGS. 11 to 15, without this being explicitly mentioned. Moreover, all features and variants described in relation to one exemplary embodiment can, in principle, also be used for the respective other exemplary embodiment, unless this is technically precluded.

Represented in the exemplary embodiment is a cable 2 having two conductors 3. (FIG. 1).

The exemplary embodiment is to be understood in such a manner that the cable 2 may also have only one conductor 3, at least one conductor 3, at least two conductors 3 or a plurality of conductors 3. In particular, the method may also be used in the case of a so-called star quad.

In the exemplary embodiment, the two conductors 3 represented are realized as stranded conductors 3 The method according to the invention is suitable, in particular, for removing the shielding 1 from two conductors 3 that are realized as a signal-line pair, in particular as a differential signal-line pair. Most particularly, the method according to the invention, as represented in the exemplary embodiment, is suitable for removing the shielding 1 from two conductors 3 that are realized as a stranded differential signal-line pair.

The description of the exemplary embodiment is to be understood as a disclosure for the method according to the invention, as well as for the device according to the invention.

The shielding 1 of the cable 2 may in principle have any desired structure. In the exemplary embodiment, it is provided that the shielding 1 is realized as a metallic shielding, in particular a metallic foil, or a metalized foil. In the exemplary embodiment, reference is made below to the fact that the shielding 1 is realized as a metalized foil 1, but the exemplary embodiment is not limited to this.

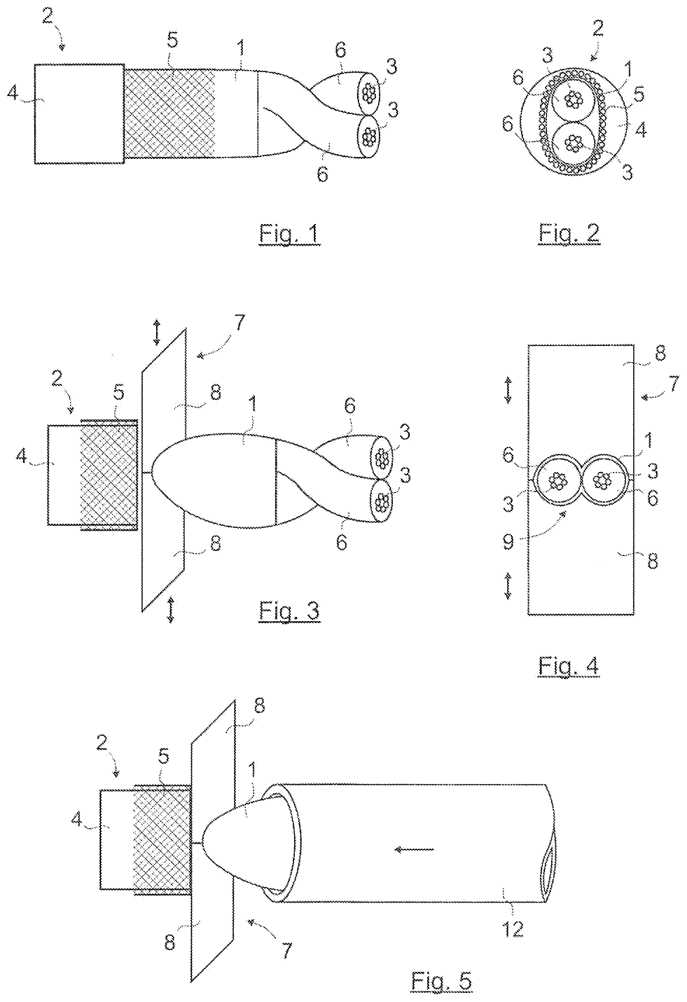

Represented in FIGS. 1 and 2, to explain the method according to the invention, is a cable 2 that has been partially stripped at one end.

A cable assembly, by which a cable 2 can be brought into the state represented in FIGS. 1 and 2, is known in principle from the prior art. In the exemplary embodiment, it may preferably first be provided that a cable sheath 4 of the cable 2 is incised at a designated location and the incised cable sheath piece that faces towards the cable end is partially or completely stripped (as represented in the exemplary embodiment). The cable sheath piece 4 pulled off the cable 2 is not represented in the figures.

In the exemplary embodiment it may preferably be provided, in a manner not represented in greater detail, that a support sleeve is crimped onto an outer conductor 5, which is located beneath the cable sheath 4 and which in the exemplary embodiment is a braided shield 5. The application of a support sleeve may also be dispensed with, if necessary, but this is not relevant for the method according to the present invention, for which reason this is not discussed in greater detail.

In order to achieve the state of the cable 2 represented in FIGS. 1 and 2, it may preferably also be provided that the free portion of the cable 2 projecting beyond the cable sheath 4 is trimmed to the intended length (zero cut).

For further processing, as represented in FIG. 3, it may be provided that the braided shield 5 is turned inside out, or folded over, such that it is folded over the cable sheath 4, or preferably over a support sleeve (not represented).

Although turning the braided shield 5 inside out has been found to be advantageous, this is not directly relevant for executing the method according to the invention.

The method according to the invention relates to the removal of a shielding 1. In the exemplary embodiment, the removal of the metalized foil 1 located under the braided shield 5 is described.

In the course of cable processing, after the shielding 1 has been incised and removed, as described in greater detail below, provision may be made to remove any insulation 6 present at the ends of the conductors 3. Here, too, a partial or full removal may be provided if necessary. The conductors 3 with the respective insulation 6 are also referred to as “cores” in the prior art.

Following the removal of the insulation 6 from the conductors 3, inner conductor contact elements (not represented) may be fastened, preferably crimped, onto the stripped conductors 3 in a known manner.

For the purpose of executing the method according to the invention for removing the metalized foil 1, it is provided that a cutting tool 7 is advanced to a cutting position on an outer surface of the metalized foil shielding 1. In the exemplary embodiment, the cutting tool 7 in this case has two cutters 8, which together enclose the metalized foil shielding 1, or the conductors 3 (including their insulation 6).

The number of cutters 8 is not of primary relevance for execution of the method according to the invention. Both one, and more than one, cutter 8 may be provided. However, it has proved particularly expedient if the cutting tool 7 has two cutters 8 arranged opposite each other. Some of the cutters 8 may also be shaping tools.

As can be seen from viewing FIG. 3 and FIG. 4 together, in the exemplary embodiment the cutting tool 7, or the cutters 8, has/have formations 9 to receive the conductors 3 (including their insulation 6) in the cutting position. Insofar as the cutting tool 7 is designed to remove the metallic foil 1 from two conductors 3, the formations 9 in the cutters 8 are configured in such a manner that, in the cutting position, the formations 9 have a generally spectacle-shaped configuration, into which the conductors 3 are inserted.

In the context of the exemplary embodiment, it is preferably provided that, in order to insert the conductors 3 into the formations 9 of the cutting tool 7 in the cutting position, the axial position of the cutting tool 7 and/or the axial position of the cable 2 is adjusted. In this way, it can be achieved that the cables 2 are positioned in such a manner in the cutting position that the formations 9 and the position of the conductors 3 match each other.

In addition, or alternatively, it may also be provided that the cutting tool 7 and/or the cable 2 are/is rotated in such a manner that the position of the conductors 3 and the formations 9 of the cutting tool 7 match.

It is advantageous if, as represented in FIGS. 3 and 4, the cutting tool 7 and the cable 2 are positioned relative to each other in such a manner that, in the cutting position, a straight line running orthogonally through the central axis of the two conductors 3 extends orthogonally in relation to the advance movement of the cutting tool 7. The advance, and retract, movement of the cutting tool 7, or of its cutters 8, is represented by the double arrows in FIGS. 3 and 4.

Preferably, the tyro conductors 3 are located in an identical horizontal plane.

Represented in FIGS. 3 and 4, as described above, is the advancing, or positioning, of the cutting tool 7.

It is to be noted that, in the context of the method according to the invention, it is not absolutely necessary for the cutting tool 7 to be advanced to the outer surface of the metalized film 1 before the method steps described below are executed. However, it has been found to be appropriate to advance the cutting tool 7 at least before the cutting phase described below, preferably also before the opening phase, described below, of the method according to the invention.

Furthermore, with regard to the second exemplary embodiment (FIGS. 11 to 15), it has also been found advantageous if the cutting tool 7 is advanced before the gaseous medium is injected into the cable 2, or under the shielding 1.

According to the invention, it is provided that a gaseous medium is injected into the cable 2 in order to apply a radially outwardly acting force to the metalized foil 1 in such a manner that the metalized foil 1 is incised by at least one of the cutters 8 of the cutting tool 7. Preferably, for this purpose the cutting tool 7 is advanced with the cutters 8 in such a manner that the cutters 8 prevent, or at least reduce, a further flow of the gaseous medium in the axial direction along the cable 2.

In the exemplary embodiment, it is provided that the gaseous medium injected into the cable 2 is air. Furthermore, in the exemplary embodiment it is provided (not represented) that a blower is used for injecting the gaseous medium, or air.

In the exemplary embodiment, the gaseous medium is hereinafter referred to as air, but the exemplary embodiment is not limited to this.

In the context of the method according to the invention it is preferably provided, as represented in the exemplary embodiment, that the air is injected into an interspace 10 radially inside, or beneath, the metalized foil 1 in such a manner that the air acts directly upon an inner surface of the metalized foil. This has the effect of opening the metalized foil 1, which is preferably a wound metalized strip.

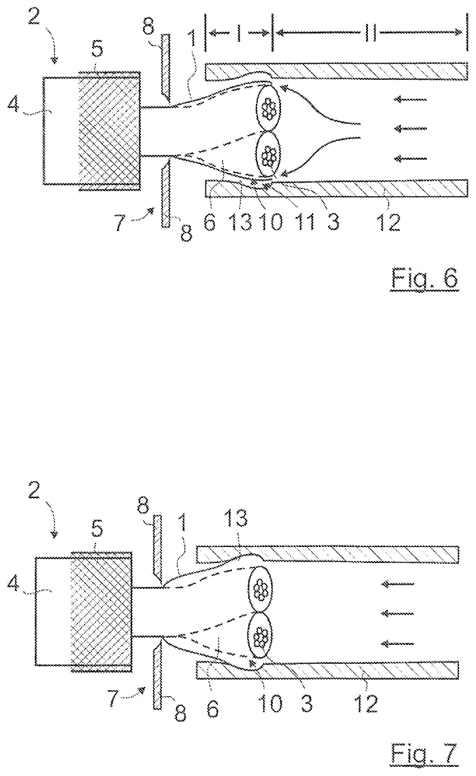

In order to achieve this, in the first exemplary embodiment according to FIGS. 5 to 10 it is preferably provided that a gas guide 12 is applied to a free end of the cable 2, at which the metalized foil 1 is exposed, in such a manner that the gas guide 12 radially surrounds the free end of the cable 2 and an axially extending portion of the exposed metalized foil 1, a preferably annular gap 11 remaining between an inner surface of the gas guide 12 and the outer surface of the metalized foil 1. In the exemplary embodiment it is provided that the gap 11 is annular. The annular gap 11 is represented in general in FIG. 6.

In the exemplary embodiment it is further provided that the gas guide 12 is realized as a tube or hose. In the following, the gas guide is referred to as a tube 12, but the exemplary embodiment is not to be understood as limited to this. This also applies to the second exemplary embodiment.

The method step of turning the tube 12 inside out over the conductors 3 and the metalized foil 1 is represented in general in FIGS. 5 and 6.

As represented in FIGS. 5 and 6, the tube 12 is preferably positioned in such a manner that a front end of the tube 12 pushed onto the cable 2 ends adjacent to the cutting tool 7. It is preferably provided in this case that there is a distance between the front end of the tube 12 and the cutting tool 7, such that the metalized foil 1 can inflate accordingly, as will be described in greater detail below.

In the exemplary embodiment it is provided, as represented in FIGS. 6 and 7, that in an opening phase the metalized foil 1 is moved radially outwardly within the tube 12 in such a manner that at least an annular portion of the metalized film 1 bears against an inner surface of the tube 12.

In the exemplary embodiment, this is achieved in that air is injected into the tube 12 in such a manner that the air flows past the free end of the cable 2, through the annular gap 11 (see FIG. 6) between the inner surface of the tube 12 and the outer surface of the metalized foil 1, in the direction of the cutting tool 8.

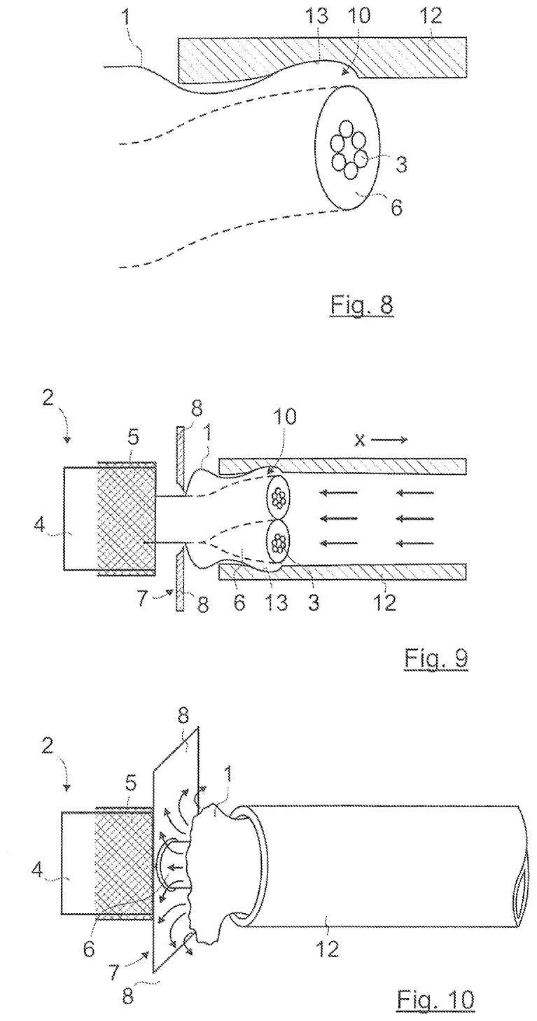

As can be seen in FIG. 6, air flows in the region II in the tube 12 towards the conductors 3, or the metalized foil 1. The constriction in the region I causes an increase in the flow velocity and, according to the Bernoulli principle, a drop in pressure. The reduced pressure in the region I causes the metalized foil 1 to open. The opened metalized foil 1 then bears against the inner surface of the tube 12, and closes the annular gap 11 as long as the pressure is maintained. It is thus a “self-sealing” system. This is represented in FIGS. 7 and 8. As can be further seen in FIGS. 7 and 8, the interspace 10 occupies the annular gap 11 when the metalized film 1 has been opened.

In the context of the method according to the invention, it may be provided that the tube 12 has a constant, or substantially constant, internal diameter. The contour of the inner surface of the tube 12 represented in FIGS. 6 to 9, in which it is provided that the inner surface of the tube 12 has a recess 13 against which the metalized film 1 can bear, facilitates closure of the annular gap 11 by the metalized film 1. In the exemplary embodiment, it is provided in this case that the inner surface of the tube 12 is provided with the recess 13 in such a manner and the tube 12 is positioned with respect to the cable 2 in such a manner that, owing to the Bernoulli principle, a front end of the metalized film 1 that faces away from the cutting tool 7 rests in the recess 13 when the blower injects the air in an opening phase.

In a manner not represented in greater detail, it may alternatively or additionally be provided in the exemplary embodiment that openings are present in the tube 12, through which air is sucked outwards in order to suck the metalized foil 1 onto the inner surface of the tube 12.

After the opening phase, the metalized foil 1 bears against the inner surface of the tube 12, as represented in FIG. 7. An enlarged detail of this is represented in FIG. 8.

According to the invention it is preferably provided that, after the opening phase, in a cutting phase, in order to incise the metalized foil 1 by means of the cutters 8 of the cutting tool 7, air is injected with gauge pressure into the tube 12 in the direction of the cutting tool 7. Preferably, a pressure surge is introduced into the tube 12 in the cutting phase in order to generate the gauge pressure. The gauge pressure, or pressure surge, increases the pressure within the metalized foil 1 to such an extent that the cutters 8 produce a defined tear edge and the foil 1 is removed. This is represented in general in FIG. 10.

It is advantageous if, as represented in FIG. 9, the gas guide 12 is moved away from the cutting tool 7 in the cutting phase while the air is being injected with gauge pressure into the gas guide 12. This is represented by the arrow X in FIG. 9. Preferably, the gas guide 12 is moved away from the cutting tool 7 to such an extent that the metalized foil 1 is no longer radially surrounded by the gas guide 12. However, complete withdrawal is not necessary to improve the cutting process; it has already been found to be advantageous if the gas guide 12 is moved in the direction of the arrow X to such an extent that the distance between the cutting tool 7 and the front end of the gas guide 12 is increased, such that the metalized foil 1 has more space to be inflated radially.

Insofar as the gas guide 12 is withdrawn from the metalized foil 1 in the direction of the arrow X, the gas guide 12, unlike the representation in FIG. 10, no longer encompasses the metalized foil 1.

It is to be noted that, in principle, it is also possible within the context of the method according to the invention, for the first exemplary embodiment, to dispense with the opening phase, or a transition between the opening phase and the cutting phase may be fluid. Preferably, it is provided that the gauge pressure, or the compressed air surge, is at least 5 bar, preferably at least 7 bar, more preferably at least 10 bar, in particular 7 to 12 bar, and more preferably 10 to 12 bar. For the second exemplary embodiment, it may furthermore be sufficient if injection is effected only once, preferably also by a pressure surge. However, an opening phase with a first pressure and a cutting phase with a second, increased pressure may also be provided analogously in the case of the second exemplary embodiment.

In the first exemplary embodiment, it is provided that the gauge pressure in the cutting phase is higher than the pressure in the opening phase. Preferably, the gauge pressure is at least 1 bar, preferably at least 2 bar, higher than the pressure in the opening phase.

In the context of the method according to the invention for the first exemplary embodiment, it is preferably provided that the foil shielding 1 is first inflated with a low gauge pressure, and then a pressure surge is effected, which results in the foil shielding 1 splitting open.

It may also be provided, in the method according to the invent on for the first exemplary embodiment, that a pressure of 2 to 7 bar, preferably 3 to 6 bar, is used for inflation in the opening phase, and then a gauge pressure of at least 7 bar is subsequently applied in the cutting phase.

The term “gauge pressure” it is to be understood to mean that the pressure is higher than the ambient pressure, or the normal pressure (1 bar).

It has been shown, in the context of the method according to the invention, that it is not absolutely necessary for the cutters 8 to completely cut through the metalized foil shielding 1in the cutting phase. It may already be sufficient if a tear edge is produced. Complete tearing-off of the metalized foil 1 may then be effected by other measures. In particular, it may already be sufficient for the cutters 8 to be moved away from the cable 2. It has been shown that the rnetalized foil 1 adheres to the cutters 8 in such a manner that the movement of the cutters 8 is sufficient to completely tear off the metalized foil 1. This applies to the first exemplary embodiment, and analogously also to the second exemplary embodiment.

It has been found to be particularly suitable if, before the cutting phase, the cutters 8 of the cutting tool 7 are advanced to the outer surface of the metalized foil 1 in such a manner that the cutters 8 bear against the metalized foil 1. Preferably, the cable 2 in this case is rotated in such a manner that the position of the formations 9 matches the position of the conductors 3. This applies to the first exemplary embodiment, and analogously also to the second exemplary embodiment.

The above description relates to the removal of the metalized foil 1, i.e. the shielding 1 of the conductors 3. In principle, however, it is also possible to use the method according to the invention to incise, or remove, the braided shield 5, or the outer conductor shielding in general. This applies to the first exemplary embodiment, and analogously also to the second exemplary embodiment.

As mentioned above, all features described for the first exemplary embodiment also apply to the second exemplary embodiment, unless this is obviously excluded. In particular, all general explanations, also in particular with regard to FIGS. 1 to 4, but also, for example, in respect of the positioning and design of the cutting tool 7, apply to the second exemplary embodiment. Moreover, in principle, a two-stage or multi-stage injection, in particular with differing pressures, may also be provided in the second exemplary embodiment, i.e., analogously, an opening phase and a cutting phase. For the second exemplary embodiment, however, it is preferable if only one pressure surge, or a single injection, with gauge pressure is effected.

As can be seen from FIGS. 11 and 12, in the second exemplary embodiment the gas guide 12 is positioned in front of the free end of the cable 2 in such a manner that an outlet opening 14 of the gas guide 12 is positioned in front of an end face 15 of the free end of the cable 2.

In the exemplary embodiment, it is provided in this case that the outlet opening 14 is positioned adjacently, preferably closely adjacently, in front of the free end of the cable 2 in such a manner that the gaseous medium, in particular air, flowing out of the outlet opening 14 is aligned with the end face 15 of the free end of the cable 2.

It is advantageous if the distance between the end face 15 and the outlet opening 14 is as small as possible, or minimal.

In the exemplary embodiment, it is represented that the diameter, or cross-sectional area, of the outlet opening 14 is the same as the diameter, or cross-sectional area, of the end face 15, which in the exemplary embodiment is constituted by the end faces of the conductors 3 and the insulation 6, as well as the end face of the shielding 1.

Alternatively, it may also be provided that the diameter, or cross-sectional area, of the outlet opening 14 is larger or smaller than the diameter, or cross-sectional area, of the end face 15 of the free end of the cable 2.

As can be further seen in the exemplary embodiment according to FIGS. 11 and 12, the gas guide 12 is preferably arranged in such a manner that a central axis of the free end of the cable 2 and a central axis of the outlet opening 14, or a central axis of the duct 17 of the gas guide 12 directly adjoining it and supplying the outlet opening 14 with the gaseous medium, are substantially coaxial with each other.

It may be provided in the exemplary embodiment that, while the gaseous medium is being injected into the cable 2, the gas guide 12 and the cutting tool 7 are moved towards and/or away from each other, optionally also oscillating. It has been shown that a slight axial movement of the gas guide 12 and/or of the cutting tool 7 and/or of the cable 2 can improve the desired removal of the exposed shielding 1. Such a movement may also be suitable for the first exemplary embodiment.

In the case of the second exemplary embodiment, incision of the shielding 1, or splitting-open of the shielding 1, is effected in a manner similar to that described with respect to the first exemplary embodiment and shown in FIG. 10, but clearly without the gas guide 12 surrounding the shielding 1 for this purpose.

Represented in FIGS. 13 and 14 is a particularly advantageous design of the gas guide 12, which is suitable in particular for the second exemplary embodiment. It is provided according to FIGS. 13 and 14 that the gas guide 12 comprises a second nozzle 16, or at least one additional nozzle 16, preferably a plurality of additional nozzles 16. In the exemplary embodiment, preferably four or more additional nozzles 16 are provided.

As can be seen in FIGS. 13 and 14, the additional nozzles 16 are preferably arranged radially outward of the outlet opening 14. The additional nozzles 16 are spacedly arrayed about and are preferably arranged in such a manner that the gaseous medium flowing out of the additional nozzle 16 flows in the direction of a central axis of the cable 2, or that the additional nozzles 16 are directed inwards.

The additional nozzles 16 are preferably punctiform. The additional nozzles 16 are preferably positioned radially outward of the outlet opening 14. It may also be provided in this case that the additional nozzles 16 are positioned radially outward of the cross-sectional area, or diameter, of the end face 15 of the free end of the cable 2. This, in particular, if the additional nozzles 16 are oriented inwards, or in the direction of the central axis of the cable 2, or the gaseous medium flows out accordingly.

It is advantageous, but not represented in the exemplary embodiment, if the at least one additional nozzle 16 is moved, preferably rotated about a central axis of the outlet opening 14, in order to generate a vortex. An oscillation may also be provided.

It may be provided that the additional nozzles 16 are arranged on a nozzle ring which accordingly oscillates or rotates about the outlet opening 14. It has been shown that the creation of a vortex of air enables the removal of the shielding 1 to be further improved.

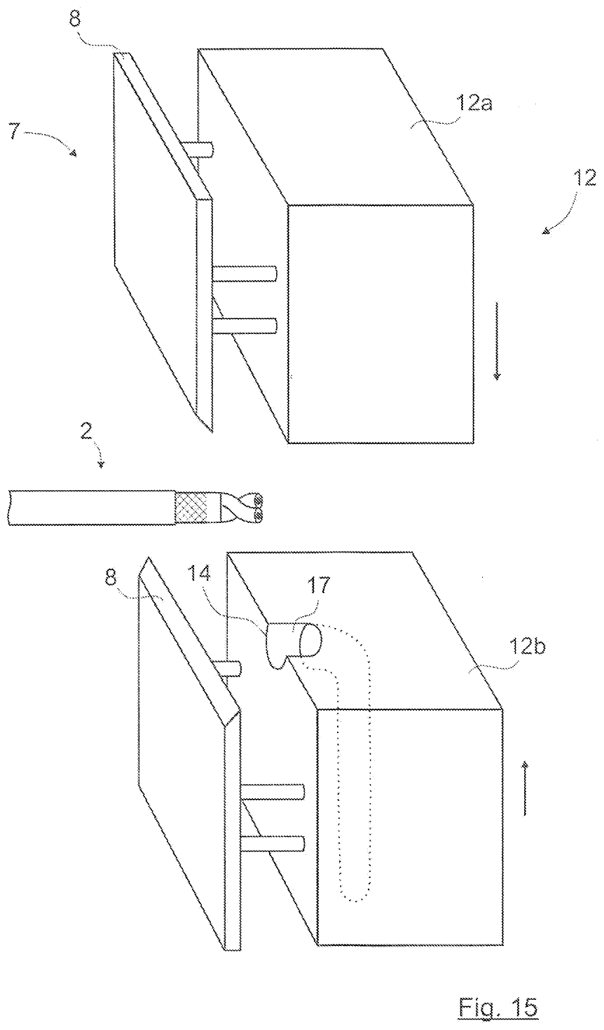

Represented in FIG. 15 is a further advantageous embodiment in which it is provided that the gas guide 12 is of a multipart design, in the exemplary embodiment a two-part design. The parts 12a, 12b of the gas guide 12 in this case may be positioned accordingly, i.e. assembled, in order to inject the air flow/gaseous media into the cable 2. In the exemplary embodiment, it is provided that a duct 17 of the gas guide 12 is realized substantially in one of the parts 12b of the gas guide 12. It is also possible, however, that both parts 12a, 12b of the gas guide 12 together realize the duct 17. In the exemplary embodiment, it is further represented that the duct 17 has a bend, of 90° in the exemplary embodiment. In the exemplary embodiment according to FIG. 15, after the outlet opening 14 the duct 17 is initially coaxial with the central axis of the free end of the cable 2. The duct 17 then bends at a right angle and runs substantially parallel to direction of advance of the parts 12a, 12b of the gas guide 12. Pipes or hoses or lines that supply the duct 17 with the gaseous medium, in particular air, can thus be connected particularly advantageously.

As can be seen in general from FIG. 15, a part 12a is mechanically connected in a rigid, or fixed, manner to a first part of the cutting tool 7 that comprises a cutter 8, while a part 12b is mechanically connected in a rigid, or fixed, manner to a second part of the cutting tool 7 that likewise comprises a cutter 8. This has the advantage that the cutting tool 7 is advanced together with the parts 12a, 12b, and the position between the cutting tool 7 and the parts 12a, 12b is rigid, or fixed, such that positioning errors in the cutting position are largely precluded.

It is preferably provided that the positioning of the cutting tool 7 in the cutting position and the positioning of the gas guide 12 in front of the end face 15 of the free end of the cable 2 are effected simultaneously.

A multipart, in particular two-part construction of the gas guide 12 may also be analogously suitable for the first exemplary embodiment, in which case, preferably, the multipart gas guide 12, in particular the two-part gas guide 12, realizes a part of the duct 17 in each case.

A method for removing an exposed shielding (1) of a cable (2), according to which a cutting tool (7) is advanced into a cutting position on an outer surface of the shielding (1), characterized in that a gaseous medium is injected into the cable (2) in order to apply a radially outwardly acting force to the shielding (1), in such a manner that the shielding (1) is incised by a cutter (8) of the cutting tool (7).

A method characterized in that the gaseous medium is injected into an interspace (10) radially inside the shielding (1), in such a manner that the gaseous medium acts directly upon an inner surface of the shielding (1).

A method characterized in that a gas guide (12) is applied to a free end of the cable (2) at which the shielding (1) is exposed, in such a manner that the gas guide (12) radially surrounds an axially extending portion of the exposed shielding (1) of the cable (2), with a preferably annular gap (11) remaining between an inner surface of the gas guide (12) and the outer surface of the shielding (1).

A method characterized in that characterized in that the shielding (1), in an opening phase, is moved radially outwards within the gas guide (12) in such a manner that at least one annular portion of the shielding (1) bears against an inner surface of the gas guide (12).

A method characterized in that characterized in that after the opening phase, in a cutting phase for the purpose of incising the shielding (1) by means of the cutter (8) of the cutting tool (7), a gas flowing in the direction of the cutting tool (7) is injected with gauge pressure into the gas guide (12).

A method characterized in that characterized in that a pressure surge is introduced into the gas guide (12) in the cutting phase in order to generate the gauge pressure.

A method characterized in that a gas guide (12) through which the gaseous medium is injected into the cable (2), and a free end of the cable (2), at which the shielding (1) is exposed, are positioned relative to each other in such a manner that an outlet opening (14) of the gas guide (12) is positioned in front of an end face (15) of the free end of the cable (2).

A method characterized in that characterized in that the outlet opening (14) is positioned adjacently, preferably closely adjacently, in front of the free end of the cable (2), in such a manner that the gaseous medium flowing out of the outlet opening (14) is aligned with the end face (15) of the free end of the cable (2).

A method characterized in that characterized in that the gas guide (12) has at least one additional, or second, nozzle (16), preferably a plurality of additional nozzles (16).

A method characterized in that characterized in that the at least one additional nozzle (16) is arranged radially outside the outlet opening (14), and/or the at least one additional nozzle (16) is arranged in such a manner that the gaseous medium flowing out of the additional nozzle (16) flows in the direction of a central axis of the cable (2), and/or the at least one additional nozzle (16) is moved, preferably rotated about a central axis of the outlet opening (14), in order to generate a vortex.

A method characterized in that characterized in that the gas guide (12) is of a multipart, preferably two-part design, and the parts (12a, 12b) of the gas guide (12) are positioned, preferably in coordination with the cutting tool (7), to inject the gaseous medium into the cable (2).

A method characterized in that characterized in that the gas guide (12) and the cutting tool (7) are moved towards each other and/or away from each other while the gaseous medium is being injected into the cable (2).

A device for removing an exposed shielding at an end of a cable (2), having a cutting tool (7) that, for the purpose of severing the shielding (1), can be advanced to an outer surface of the shielding (1), characterized in that a gas guide (12) and a blower are provided to inject a gaseous medium beneath the shielding (1) in such a manner that the shielding (1) is subjected to a radially outwardly acting force, in such a manner that a cutter (8) of the cutting tool (7) incises the outwardly pressed shielding (1).

A device characterized in that the gas guide (12) is applied to the end of the cable (2) at which the shielding (1) is exposed, in such a manner that the gas guide (12) radially surrounds a portion of the exposed shielding (1) extending in the axial direction of the cable (2), wherein the gas guide (12) is configured in such, a manner that an annular gap (11) remains between the inner surface of the gas guide (12) and the outer surface of the shielding (1).

A device characterized in that the gas guide (12) and the end of the cable (2) are positioned relative to each other in such a manner that an cutlet opening (14) of the gas guide (12) is positioned in front of an end face (15) of the end of the cable (2).

A method for removing an exposed shielding from a cable comprising the steps of: providing a cutting tool that has a cutter; advancing the cutting tool into a cutting position adjacent an outer surface of the exposed shielding; providing a gaseous medium, and injecting the gaseous medium into a free end of the cable to apply a radially outwardly acting force upon the exposed shielding so that the exposed shielding is incised by the cutter of the cutting tool.

A method wherein the gaseous medium is injected into an interspace radially inside the exposed shielding; and the injected gaseous medium acts directly upon an inner surface of the exposed shielding.

A method and further comprising the step of providing a gas guide and applying the gas guide to a free end of the cable where the shielding is exposed, in a manner wherein the gas guide radially surrounds an axially extending portion of the exposed shielding of the cable and an annular gap is between an inner surface of the gas guide and an outer surface of the shielding.

A method and further comprising the step of: providing an opening phase wherein the exposed shielding is moved radially outwards within the gas guide in such a manner that at least one annular portion of the exposed shielding bears against an inner surface of the gas guide when the gaseous medium is injected into the interspace.

A method and further comprising the step of: providing a cutting phase that occurs after the opening phase, and wherein, in the cutting phase, for the purpose of incising the exposed shielding by means of the cutter of the cutting tool the gaseous medium flows in the direction of the cutting tool and is injected with gauge pressure into the gas guide.

A method and further comprising the step of: providing a pressure surge that is introduced into the gas guide in the cutting phase in order to generate the gauge pressure.

A method and further comprising the step of: providing a gas guide through which the gaseous medium is injected into the cable at the free end of the cable, at which the shielding is exposed, and the gas guide and the free end of the cable are positioned relative to one another in such a manner that an outlet opening defined by the gas guide is positioned in front of an end face of the free end of the cable.

A method wherein the outlet opening of the gas guide is positioned adjacent the free end of the cable so that the gaseous medium flowing out of the outlet opening is generally coaxially aligned with the end face of the free end of the cable.

A method and further comprising: a second nozzle defined in the gas guide proximate to the outlet opening defined in the gas guide through which the gaseous medium flows.

A method wherein the second nozzle is arranged radially outside the outlet opening, and the second nozzle is positioned relative to the outlet opening defined in the gas guide so that the gaseous medium flowing out of the second nozzle flows in the direction of a central axis of the cable.

A method wherein the gas guide is a multi-part design, and the multi-parts of the gas guide are positioned, and oriented, in coordination with the cutting tool, to inject the gaseous medium into the free end of the cable.

A method and further comprising the step of: controllably moving the gas guide and the cutting tool relative to one another while the gaseous medium is being injected into the free end of the cable.

A device for removing an exposed shielding at an end of a cable comprising: a cutting tool having a cutter that can be advanced to an outer surface of the exposed shielding: and a gas guide: and a blower, and wherein the blower operatively communicates with the gas guide to provide a pressurized gaseous medium thereto, and the gas guide is positioned and oriented relative to a free end of the cable to inject the pressurized gaseous medium beneath the exposed shielding so that the exposed shielding is subjected to a radially outwardly acting force, in such a manner that the cutter of the cutting tool incises the outwardly pressed exposed shielding.

A device wherein the gas guide is applied to the free end of the cable at which the shielding is exposed, in such a manner that the gas guide radially surrounds a portion of the exposed shielding extending in the axial direction of the cable, and wherein the gas guide is configured so that an annular gap is between an inner surface of the gas guide and an outer surface of the exposed shielding.

A device wherein the gas guide and the free end of the cable are positioned and oriented relative to each other in such a manner that an outlet opening defined in the gas guide is positioned in front of an end face of the free end of the cable and is coaxially aligned therewith.

A device wherein the injection of the pressurized gaseous media into the free end of the cable and below the shielding causes the exposed shielding to move radially outwardly to engage in the cutter of the cutting device to cause the incising of the exposed shielding.

A method wherein the second nozzle is arranged radially outside the outlet opening, and the second nozzle is positioned relative to the outlet opening defined in the gas guide so that the gaseous medium flowing out of the second nozzle flows in the direction of a central axis of the cable and the second nozzle is rotated about a central axis of the outlet opening to generate a vortex.

In compliance with the statute, the present invention has been described in language more or less specific as to the structural and methodical features. It is to be understood, however, that the invention is not limited to the specific features shown and described since the means herein disclosed comprise preferred forms of putting the invention into effect. The invention is therefore claimed, in any of its forms or modifications, within the proper scope of the appended claims appropriately interpreted in accordance with the doctrine of equivalents.

I claim:

1. A method for removing an exposed shielding from a cable comprising the steps of:
providing a cutting tool that has a cutter;
advancing the cutting tool into a cutting position adjacent an outer surface of the exposed shielding;
providing a gaseous medium. and injecting the gaseous medium into a free end of the cable to apply a radially outwardly acting force upon the exposed shielding so that the exposed shielding is incised by the cutter of the cutting tool.

2. The method as claimed in claim 1 and wherein the gaseous medium is injected into an interspace radially inside the exposed shielding; and
the injected gaseous medium acts directly upon an inner surface of the exposed shielding.

3. The method as claimed in claim 2 and further comprising the step:
providing a gas guide and applying the gas guide to a free end of the cable where the shielding is exposed, in a manner wherein the gas guide radially surrounds an axially extending portion of the exposed shielding of the cable and an annular gap is between an inner surface of the gas guide and an outer surface of the shielding.

4. The method as claimed in claim 3 and further comprising the step of:
providing an opening phase wherein the exposed shielding is moved radially outwards within the gas guide in such a manner that at least one annular portion of the exposed shielding bears against an inner surface of the gas guide when the gaseous medium is injected into the interspace.

5. The method as claimed in claim 4 and further comprising the step of:
providing a cutting phase that occurs after the opening phase, and wherein, in the cutting phase, for the purpose of incising the exposed shielding by means of the cutter of the cutting tool the gaseous medium flows in the direction of the cutting tool and is injected with gauge pressure into the gas guide.

6. The method as claimed in claim 5 and further comprising the step of:
providing a pressure surge that is introduced into the gas guide in the cutting phase in order to generate the gauge pressure.

7. The method as claimed in claim 1 and further comprising the step of:
providing a gas guide through which the gaseous medium is injected into the cable at the free end of the cable, at which the shielding is exposed, and the gas guide and the free end of the cable are positioned relative to one another in such a manner that an outlet opening defined by the gas guide is positioned in front of an end face of the free end of the cable.

8. The method as claimed in claim 7 and wherein the outlet opening of the gas guide is positioned adjacent the free end of the cable so that the gaseous medium flowing out of the outlet opening is generally coaxially aligned with the end face of the free end of the cable.

9. The method as claimed in claim 7 and further comprising:
a second nozzle defined in the gas guide proximate to the outlet opening defined in the gas guide through which the gaseous medium flows.

10. The method as claimed in claim 9 and wherein
the second nozzle is arranged radially outward of the outlet opening, and the second nozzle is positioned relative to the outlet opening defined in the gas guide so that the gaseous medium flowing out of the second nozzle flows in the direction of a central axis of the cable.

11. The method as claimed in claim 3 and wherein
the gas guide is a multi-part design, and the multi-parts of the gas guide are positioned, in coordination with the cutting tool, to inject the gaseous medium into the free end of the cable.

12. The method as claimed in claim 3 and further comprising the step of:
controllably moving the gas guide and the cutting tool relative to one another while the gaseous medium is being injected into the free end of the cable.

13. A device for removing an exposed shielding at an end of a cable comprising:
a cutting tool having a cutter that can be advanced to an outer surface of the exposed shielding; and
a gas guide; and
a blower, and wherein the blower operatively communicates with the gas guide to provide a pressurized gaseous medium thereto, and the gas guide is positioned and oriented relative to a free end of the cable to inject the pressurized a gaseous medium beneath the exposed shielding so that the exposed shielding is subjected to a radially outwardly acting force, in such a manner that the cutter of the cutting tool incises the outwardly pressed exposed shielding.

14. The device as claimed in claim 13 and wherein the gas guide is applied to the free end of the cable at which the shielding is exposed, in such a manner that the gas guide radially surrounds a portion of the exposed shielding extending in the axial direction of the cable, and wherein the gas guide is configured so that an annular gap is between an inner surface of the gas guide and an outer surface of the exposed shielding.

15. The device as claimed in claim 13 and wherein the gas guide and the free end of the cable are positioned and oriented, relative to each other, in such a manner that an outlet opening defined in the gas guide is positioned in front of an end face of the free end of the cable and is coaxially aligned therewith.

16. The device as claimed in claim 13 and wherein the injection of the pressurized gaseous media into the free end of the cable, and below the shielding, causes the exposed shielding to move radially outwardly to engage the cutter of the cutting device to cause the incising of the exposed shielding.

17. The method as claimed in claim 9 and wherein the second nozzle is arranged radially outward of the outlet opening.

18. The method as claimed in claim 9 and wherein the second nozzle is positioned relative to the outlet opening defined in the gas guide so that the gaseous medium flowing out of the second nozzle flows in the direction of a central axis of the cable.

19. The method as claimed in claim 9 and wherein and the second nozzle is rotated about a central axis of the outlet opening to generate a vortex.

20. The device as claimed in claim 13 and wherein the cutter of he cutting device is heated.
